(19) United States
(12) Patent Application Publication
(10) Pub. No.: US 2015/0161578 A1
(43) Pub. Date: Jun. 11, 2015

(54) METHOD AND APPARATUS FOR PROVIDING NAVIGATION-CENTRIC BILLING AND PAYMENT

(71) Applicant: Nokia Corporation, Espoo (FI)

(72) Inventors: Zahid Ahmed, Westborough, MA (US); Jarno Malmstrom, Espoo (FI)

(73) Assignee: Nokia Corporation

(21) Appl. No.: 14/404,995

(22) PCT Filed: Jun. 4, 2013
(86) PCT No.: PCT/US2013/044070

§ 371 Date: Dec. 2, 2014

Related U.S. Application Data
(60) Provisional application No. 61/655,224, filed on Jun. 4, 2012.

(51) Int. Cl. G06Q 20/14

(52) U.S. Cl. CPC G06Q 20/14

(57) ABSTRACT

An approach is provided for managing vehicle-related payment and/or billing transactions using a navigation-based user interface. A navigation extensions platform determines payment information, billing information, or a combination thereof associated with one or more vehicle related services. The navigation extensions platform causes, at least in part, a rendering of the payment information, the billing information, or a combination thereof on a navigation-based user interface associated with a vehicle, a device associated with the vehicle, or a combination thereof. The navigation extensions platform further causes, at least in part, an initiation of one or more payments to the one or more vehicle-related services based, at least in part, on one or more interactions with the navigation-based user interface.

### RELATED APPLICATIONS

This application claims priority to U.S. Provisional Patent Application Ser. No. 61/655,224 filed Jun. 4, 2012 entitled “Method and System for Providing Navigation-Centric Billing and Payment,” which is incorporated herein by reference in its entirety.

### BACKGROUND

Service providers and device manufacturers (e.g., wireless, cellular, etc.) are continually challenged to deliver value and convenience to consumers by, for example, providing compelling network services. One area of interest has been the development of mapping and/or navigation applications that provide users of mobile devices (e.g., mobile phones, tablets, personal navigation devices, etc.) and/or infotainment systems (e.g., a vehicle navigation head unit) with substantially real-time location-based information to assist them with their travels. More specially, one area of development relates to integrating additional services into such navigation systems and/or applications. However, as the number of available services and service providers increases, integration becomes increasingly complex, particularly in the context of billing and payment for such services. Accordingly, service providers and device manufacturers face significant technical challenges in providing an end-to-end solution for billing and payment for navigation-centric services.

### SOME EXAMPLE EMBODIMENTS

Therefore, there is a need for an approach for managing vehicle-related payment and/or billing transactions with a navigation-based user interface.

According to one embodiment, a method comprises determining payment information, billing information, or a combination thereof associated with one or more vehicle-related services. The method also comprises causing, at least in part, a rendering of the payment information, the billing information, or a combination thereof on a navigation-based user interface associated with a vehicle, a device associated with the vehicle, or a combination thereof. The method further comprises causing, at least in part, an initiation of one or more payments to the one or more vehicle-related services based, at least in part, on one or more interactions with the navigation-based user interface.

According to another embodiment, an apparatus comprises at least one processor, and at least one memory including computer program code for one or more computer programs, the at least one memory and the computer program code configured to, with the at least one processor, cause, at least in part, the apparatus to determine payment information, billing information, or a combination thereof associated with one or more vehicle-related services. The apparatus also causes, at least in part, a rendering of the payment information, the billing information, or a combination thereof on a navigation-based user interface associated with a vehicle, a device associated with the vehicle, or a combination thereof. The apparatus further causes, at least in part, an initiation of one or more payments to the one or more vehicle-related services based, at least in part, on one or more interactions with the navigation-based user interface.

According to another embodiment, a computer-readable storage medium carries one or more sequences of one or more instructions which, when executed by one or more processors, cause, at least in part, an apparatus to determine payment information, billing information, or a combination thereof associated with one or more vehicle-related services. The apparatus also causes, at least in part, a rendering of the payment information, the billing information, or a combination thereof on a navigation-based user interface associated with a vehicle, a device associated with the vehicle, or a combination thereof. The apparatus further causes, at least in part, an initiation of one or more payments to the one or more vehicle-related services based, at least in part, on one or more interactions with the navigation-based user interface.

According to another embodiment, an apparatus comprises means for determining payment information, billing information, or a combination thereof associated with one or more vehicle-related services. The apparatus also comprises means for causing, at least in part, a rendering of the payment information, the billing information, or a combination thereof on a navigation-based user interface associated with a vehicle, a device associated with the vehicle, or a combination thereof. The apparatus further comprises means for causing, at least in part, an initiation of one or more payments to the one or more vehicle-related services based, at least in part, on one or more interactions with the navigation-based user interface.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-20 and 36-38.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of managing vehicle-related payment and/or billing transactions using a navigation-based user interface, according to one embodiment;

FIG. 2 is a diagram of the components of a navigation extensions platform, according to one embodiment;

FIG. 3 is a diagram of the components of a navigation extensions platform, according to one embodiment;

FIGS. 4-6 are flowcharts of processes for managing vehicle-related payment and/or billing transactions using a navigation-based user interface, according to one embodiment;

FIG. 7 is a diagram depicting a process flow for a navigation application operating in association with a navigation extensions platform, according to one embodiment;

FIG. 8 is a diagram depicting a payment flow for a parking service operating in association with a navigation extension platform, according to one embodiment;

FIG. 9 is a diagram of a user interface utilized in the processes of FIGS. 4-6, according to various embodiments;

FIG. 10 is a diagram of hardware that can be used to implement an embodiment of the invention;

FIG. 11 is a diagram of a chip set that can be used to implement an embodiment of the invention; and

FIG. 12 is a diagram of a mobile terminal (e.g., handset) that can be used to implement an embodiment of the invention.

### DESCRIPTION OF SOME EMBODIMENTS

Examples of a method, apparatus, and computer program for managing vehicle-related payment and/or billing transactions using a navigation-based user interface are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to vehicle-based navigation, it is contemplated that the approaches of the various embodiments are applicable to navigation with respect to any mode of transport including, but not limited to, walking, bicycling, public transportation, and the like. Additionally, while the various embodiments are discussed with respect to vehicle-related services (e.g., parking, tolls, car washes, etc.), it is also contemplated that any service, including non-vehicular services, can be used with the approaches of the various embodiments.

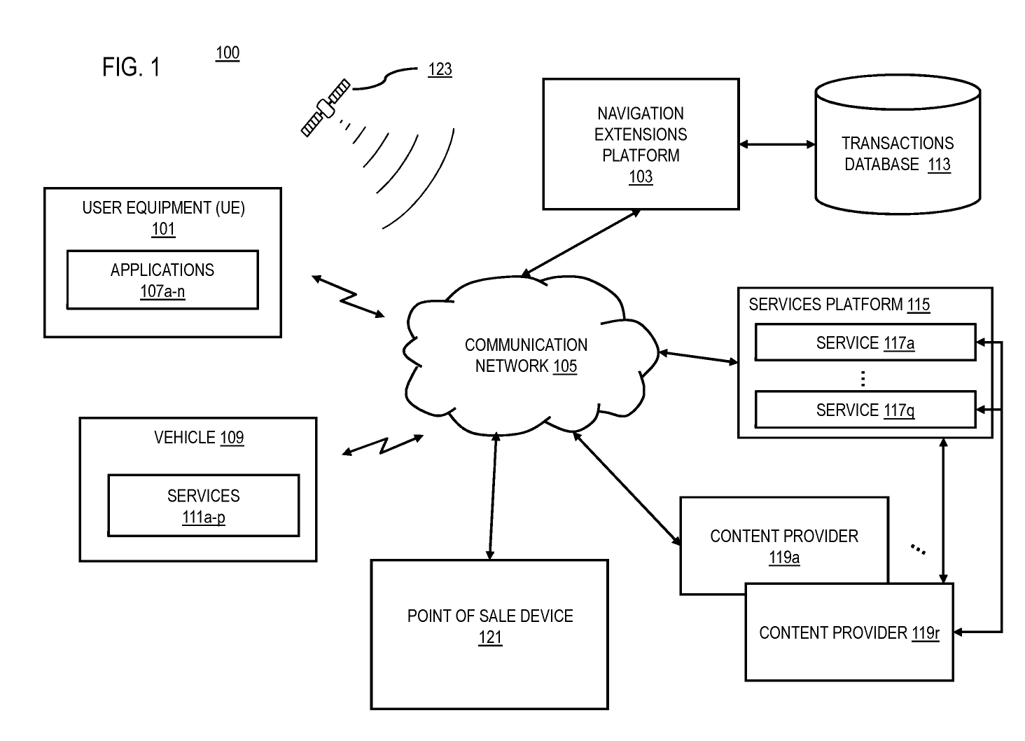

FIG. 1 is a diagram of a system capable of managing vehicle-related payment and/or billing transactions using a navigation-based user interface, according to one embodiment. As previously discussed, navigation systems, services, and/or applications are increasingly becoming integrated with a variety of location-based services. Many of these services (e.g., parking services, parking meters, toll booths, car washes, gas pumps, fast food drive-thru windows, etc.) depend on specific billing and payment from end users. However, it is often difficult or cumbersome to initiate such billing or payment transactions when a user is engaged in navigation activities.

For example, while accessing a driving navigation system or application, a user's attention is generally focused on the act of driving. Moreover, the user's attention may also be focused on obtaining navigation guidance or instructions from the navigation system. As a result, it can be difficult for the user to engage in or perform billing or payment related functions to access the services that might be presented to the user during navigation (e.g., a parking service). Typically, a user may have to exit the navigation application or otherwise access another application or service to manage access to the desired services. This can ultimately lead to a poor user experience, particularly when the user cannot divert his or her attention to attend to billing or payment for such services while driving or performing other navigation related functions.

To address this problem, a system 100 of FIG. 1 introduces the capability to manage vehicle-related payment and/or billing transactions using a navigation-based user interface. As shown in FIG. 1, the system 100 comprises a user equipment (UE) 101 such as a mobile device (e.g., a mobile phone, a tablet, a personal navigation device, etc.) and/or a vehicle infotainment system (e.g., a car navigation head unit, a navigation enabled mobile device, etc.) having connectivity to a navigation extensions platform 103 via a communication network 105. The UE 101 includes or has access to one or more applications 107a-107n (also collectively referred to as applications 107). By way of example, the applications 107 may include mapping and/or navigation applications, infotainment applications, parking applications, traffic applications, fuel applications, mobile payment applications, original equipment manufacturer (OEM)/business-to-business (B2B) applications (e.g., a navigation application, web applications, native applications, etc.), location-based applications (e.g., enabling location “check-ins”), etc. The system 100 also includes a vehicle 109 (e.g., a car) including or having access to one or more services 111a-111p (e.g., a communication service, a navigation service, an infotainment service, or a combination thereof) (also collectively referred to as services 111) having connectivity to the navigation extensions platform 103 via the communication network 105. In some cases, the UE 101 is associated with or otherwise installed in the vehicle 109. In one embodiment, the UE 101 is configured with one or more location-based technologies (e.g., global positioning system (GPS) receivers, cellular triangulation, assisted-GPS (A-GPS), etc.) to facilitate navigation and other location-based applications 107 and/or services 117. In some embodiments, the navigation extensions platform 103 may include or may be referred to as an vehicle extensions platform (e.g., a platform that extends vehicle-centric functionality or services), a service extensions platform (e.g., a platform that provides additional functionality to navigation applications 107 executing on the UE 101), or a combination thereof.

In one embodiment, the navigation extensions platform 103 may include or be associated with at least one transactions database 113. In one example embodiment, the navigation extensions platform 103 may exist in whole or in part within the UE 101, or independently, and the at least one transactions database 113 may exist in whole or in part within the navigation extensions platform 103. The at least one transactions database 113 may include, at least in part, one or more credentials (e.g., a username and password, federated identity/account information, credit card account numbers, back account numbers, registration/subscription information, etc.), transactions records/reports, payment history information, point of interest (POI) information, one or more payment/billing restrictions (e.g., when the current location is within a threshold distance from the POI location), etc.

The UE 101 is also connected to a services platform 115 via the communication network 105. In one embodiment, the services platform 115 includes one or more services 117a-117q (also collectively referred to as services 117). The services 117 may include a wide variety of services such as content provisioning services for one or more of the applications 107, one or more of the services 111, or a combination thereof. By way of example, the services 117 may include one or more online services or content (e.g., digital content that can be obtained online such as mapping data, media content, etc.) or one or more offline services or content (e.g., physical content or services such as parking services, car washes, tolls, food, etc. that may be purchased at physical retail locations). In one embodiment, the UE 101, the vehicle 109, the services platform 115, and the services 117 also have connectivity to one or more content providers 119a-119r (also collectively referred to as content providers 119). The content providers 119 also may provision a wide variety of content (e.g., maps, navigation routes, POI information, etc.) to the components of the system 100. In one embodiment, the navigation extensions platform 103, the services platform 115, the services 117, and the content providers 119 are associated with at least one point of sale (POS) device 121 (e.g., mobile parking payment operators (MPPOs) for the use case of parking services). In one embodiment, the at least one POS device 121 and/or MPPOs record user transactions conducted via the navigation extensions platform 103 for payment resolution, payment history information (i.e., tracking), etc.

In one embodiment, the navigation extensions platform 103, the applications 107 (e.g., a navigation application), or a combination thereof may utilize the one or more location-based technologies of the UE 101 (e.g., GPS) to determine a location of the UE 101 (e.g., on a specific route, on the home street of a user, close to an office, etc.) to make a request to one or more services 117 for location-based data (e.g., mapping and/or navigation information) based on a position relative to the UE 101, or a combination thereof. For example, the UE 101 may include a GPS receiver to obtain geographic coordinates from the satellites 123 to determine its current location.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, the system 100 determines payment information, billing formation, or a combination thereof associated with one or more vehicle-related services (e.g., parking services, car washes, fuel services, tolls, food, etc.). More specifically, in one embodiment, the system 100 determines the payment information, the billing information, or a combination thereof from one or more point of sale devices (e.g., the at least one point of sale device 121) associated with one or more vehicle-related services.

In one or more embodiments, the system 100 causes, at least in part, a rendering of the payment information, the billing information, or a combination thereof on a navigation-based user interface associated with a vehicle (e.g., the vehicle 109), a device associate with the vehicle (e.g., the UE 101), or a combination thereof. By way of example, in a parking use case, the navigation-based user interface may display the name of an area or district of a city (e.g., Prenzlauer Berg of Berlin, Germany), the cost of parking in that area (e.g., on the street—5 [symbol] /hour and free 18:00-06:00), the status of payment (e.g., payment started, payment stopped, etc.), the total payment transferred (e.g., 4.5 [symbol] for 43:21 minutes), etc.

In one embodiment, the system 100 determines one or more credentials associated with a user of the vehicle (e.g., the vehicle 109), the device (e.g., the UE 101), or a combination thereof, wherein one or more payments to one or more vehicle-related services (e.g., parking services) are based, at least in part, on the one or more credentials. By way of example, a user can register with the system 100 to create a user account. In one embodiment, the user may register for an account in the context of a federated identity/account (e.g., a single-sign on (SSO) identity or account). The user can also register their payment or account information (e.g., credit card numbers, bank account numbers, etc.) and can link their parking service billing account linked with the federated/identity account. In one example use case, a user pays a subscription charge for using the parking service with the account information. This subscription charge may be paid to the operator of the system 100. In one embodiment, the operator of the system 100 may share user account and/or billing account information with a service 117 provider. By way of example, the sharing of the user account and/or billing account information may be performed by the system 100 using Payment Card Industry (PCI) compliant billing systems.

In one embodiment, the system 100 causes, at least in part, an initiation of one or more payments to the one or more vehicle related services (e.g., parking services) based, at least in part, on one or more interactions with the navigation-based user interface (e.g., a touch, a tapping, a long press, a voice command, etc.). By way of example, the navigation-based user interface may include a “start payment” interactive interface element and once a user interacts with this element, the system 100 initiates the one or more may payments. By way of further example, the system 100 may display a map depicting one or more POIs that may include one or more payment gateway details for fast setup of the payment/billing process. In one embodiment, when a user highlights or selects a POI, the POI information including payment and account related data is presented by the system 100 within the navigation-based user interface (e.g., as part of a new window, a side frame or menu, or an enlarged icon over a map, etc.). Moreover, if the POI is one-click payment ready, then the system 100 can enable a user to initiate the payment (e.g., from a federated identity/account) by just selecting the POI.

In one or more embodiments, the system 100 processes and/or facilitates a processing of one or more payments to determine payment resolution information (e.g., payment deficiencies), payment history information (i.e., tracking), or a combination thereof. As previously discussed, in one embodiment, the navigation extensions platform 103, the services platform 115, the services 117, and the content providers 119 are associated with at least one point of sale device 121 (e.g., a MPPO for the use case of parking services). In one embodiment, the at least one POS device 121 and/or a MPPO records user transactions conducted via the system 100. The user transactions record then, for instance, can be reported back to the system 100 by the at least one POS device 121, for example, for compiling payment resolution information, payment history information, or a combination thereof.

In one embodiment, the system 100 determines one or more transaction reports based, at least in part, on the one or more payments to cause, at least in part, at least one update of the payment information, the billing information, or a combination thereof. For example, in some embodiments, the system 100 receives one or more transaction reports from one or more POS devices and/or the MPPOs to enable proper crediting to the user's account and/or monetization of the user transactions (e.g., one or more payments). In particular, in one embodiment, the navigation extensions platform 103 may include or may be referred to as a monetization platform 103 or service. The monetization platform 103, for instance, can enable the interaction of subscription and/or payment enablers (e.g., payment methods such as credit cards, operator billing, third-party money accounts, etc.) with the system 100.

In another embodiment, the system 100 causes, at least in part, at least one aggregation of the payment information, the billing information, the one or more payments, or a combination thereof to enable at least one access of one or more other services (e.g., additional services or functionalities provided by the services platform 115, the services 117, and/or the content providers 119) via the navigation-based user interface. More specifically, in one embodiment, the system 100 causes, at least in part, an aggregation of one or more user transactions and related billing/payments across multiple services 117, multiple instances of the services 117, the at least one POS device 121, MPPOs, and the like. By way of example, the system 100 enables aggregation or processing of one or more transactions related to one type of service from the at least one POS device 121 or MPPOs (e.g., parking services), one type of service from multiple POSs or MPPOs, and/or multiple types of services from multiple POSs or MPPOs. In one example use case, multiple parking service providers (e.g., from different regions such as Denmark, Sweden, and the United Kingdom) may log and report transaction reports or usage records to the system 100. In another aggregation use case, different service providers via respective POSs may log and send usage records to the system 100. The second example use case provides for generalization of the process to multiple service providers that provide types of services other than parking services. In this way, the system 100 becomes a general payment processor that can handle transactions from a variety of service types. Further, in one embodiment, the system 100 supports aggregation of one or more transactions for more efficient processing. For example, one or more transactions can be aggregated by the system 100 based on time, wherein the one or more transactions are collected for a period of time (e.g., a week, a month, etc.) and then processed by the system 100 collectively at the end of the period. In addition or alternatively, the transactions can be batched until their collective value meets or exceeds a threshold (e.g., 10 [symbol] ). In one embodiment, the threshold can be based on the amount of risk that can be tolerated by a service provider.

In on embodiment, the system 100 causes, at least in part, at least one transmission of one or more application programming interfaces (APIs) to one or more third-party service providers to enable the navigation-based user interface to access one or more other services from the one or more applications (e.g., the applications 107) or one or more systems of the UE 101. In some embodiments, the system 100 is also accessible to external partners such as original equipment manufacturers (OEMs) and other third-parties. For example, the OEMs may be responsible for producing or manufacturing the UE 101 and/or mapping and/or navigation applications 107 executing on the UE 101. In developing the UE 101 and/or applications 107, the OEMs/third parties may access the APIs of the system 100 to enable billing and payment functions. In one embodiment, the OEMs/third parties may operate respective OEM/third-party platforms to interface with the system 100. For example, the OEM/third-party platforms may support payment and billing for additional mapping data for use at the UE 101. The payment and billing for such additional data may then be facilitated by the system 100.

Moreover, in one embodiment, the system 100 exposes one or more APIs to support subscriptions and entitlements for one or more services (e.g., a service 117) as well as for payments for the subscriptions and entitlements. For example, a user can interact with a subscription API through a navigation application 107, for example, and/or the UE 101 (e.g., a head unit, a mobile phone, a tablet, etc.). The subscription API enables signaling of the user's intent to initiate a subscription with a navigation-related service. Once the subscription is initiated, the internal entitlement API manages the specific service, functions, data (e.g., mapping data), etc. to which the user is entitled based on his or her subscription. Further, in one embodiment, the subscription API and the entitlement API may interact with a payment gateway API to initiate one or more payments (e.g., recurring payments) for the subscriptions and entitlements. More specifically, the payment gateway API can be a third-party or external payment provider. In other embodiments, the payment gateway may be included with the navigation extensions platform 103 and/or the services 117.

In one or more embodiments, the system 100 determines location information, contextual information, or a combination thereof based, at least in part, on the vehicle (e.g., the vehicle 109), the device (e.g., the UE 101), or a combination thereof. As previously discussed, the UE 101 may be configured with one or more location-based technologies (e.g., GPS, cellular triangulation, A-GPS, etc.) to facilitate navigation and other location-based applications 107 and/or services 117. Consequently, in one example use case, the system 100 can determine that the vehicle 109, for example, is in Prenzlauer Berg district or region of Berlin, for example, where on street parking is 5 [symbol] /hour and free from 18:00-06:00.

In one embodiment, the system 100 causes, at least in part, at least one transmission of the location information, the contextual information, or a combination thereof to the one or more vehicle-based services, the one or more other services, or a combination thereof. For example, payment/billing may be restricted to certain locations (e.g., on a specified route, when the current location and POI location are substantially the same, when the current location is within a threshold distance from the POI location, etc.) or the amount of payment may depend on a specific location (e.g., parking is free on the home street of a user, or an employer has paid parking fees close to the office, etc.).

In another embodiment, the system 100 determines at least one POI associated with the location information, the contextual information, or a combination thereof. For example, the system 100 may determine that a parking lot or garage, a car wash, etc. is in the vicinity of the vehicle, the device, or a combination thereof. In one embodiment, the system 100 then causes, at least in part, a rendering of a representation of the at least one POI (e.g., a simplified glyph) on the navigation-based user interface of the UE 101. As previously discussed, the POIs may have information and provide some visual indication of a user's account status relating to the service provider of the POI (e.g., “existing valid contract,” “no contract,” “no access,” “payment due,” “ready for one-click payment,” etc.).

In one embodiment, the system 100 can determine at least one interaction with the representation of the at least POI. For example, the system 100 can determine that a user has tapped a parking lot icon or glyph, has said a voice command such as “parking lot,” etc. In one or more embodiments, the system 100 causes, at least in part, a rendering of other payment information, other billing information, or a combination thereof associated with the at least one POI on the navigation-based user interface based, at least in part, on the at least one interaction (e.g., a tapping). More specifically, in one embodiment, when a user highlights or selects a POI, the system 100 can present the POI information including payment and account related data on the navigation-based user interface (e.g., as part of a new window, a side frame or menu, or an enlarged icon over a map, etc.). By way of example, the displayed payment and account data can include information such as service description and pricing details, which are needed for a user to decide to make a one-click payment. In addition, the payment and account data may include non-displayed information, such as payment gateway details that are needed for processing the one-click payment. Further, the user can change the payment and account data details if necessary. If the POI has a visual indication that it is one-click payment ready, then the system 100 can enable a user to initiate the payment by just selecting the POI without displaying the payment and/or account details.

By way of example, the UE 101, the navigation extensions platform 103, the applications 107, the vehicle 109, the services 111, the at least one transactions database 113, the services platform 115, the services 117, the content providers 119, the at least one POS device 121, and the satellites 123 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

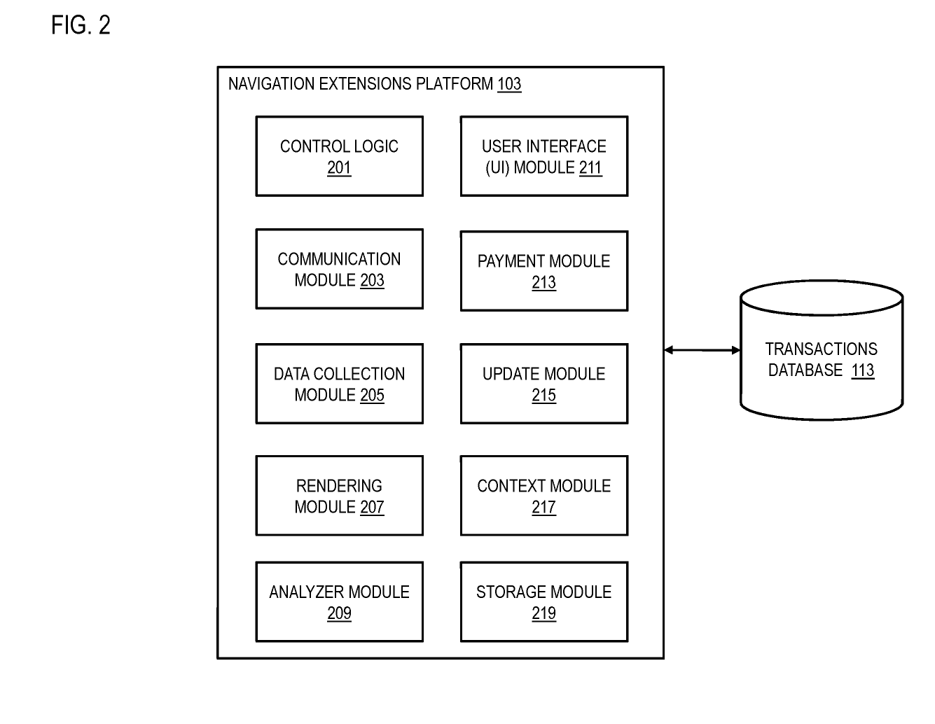

FIG. 2 is a diagram of the components of a navigation extensions platform 103, according to one embodiment. By way of example, the navigation extensions platform 103 includes one or more components for managing vehicle-related payment and/or billing transactions with a navigation-based user interface. It is contemplated that the functions of these components may be combined in one or more components or performed by other components of equivalent functionality. In this embodiment, the navigation extensions platform 103 includes a control logic 201, a communication module 203, a data collection module 205, a rendering module 207, an analyzer module 209, a user interface (UI) module 211, a payment module 213, an update module 215, a context module 217, and a storage module 219.

In one embodiment, the control logic 201 oversees tasks, including tasks performed by the communication module 203, the data collection module 205, the rendering module 207, the analyzer module 209, the user interface (UI) module 211, the payment module 213, the update module 215, the context module 217, and the storage module 219. For example, although the other modules may perform the actual task, the control logic 201 may determine when and how those tasks are performed or otherwise direct the other modules to perform the task. In one embodiment, the control logic 201 is used to cause, at least in part, at least one transmission of one or more APIs to one or more third-party service providers (e.g., an OEM) to enable the navigation-based user interface to access one or more other services associated with the applications 107 or one or more systems of the UE 101.

The communication module 203 in certain embodiments is used for communication between the UE 101, the navigation extensions platform 103, the applications 107, the vehicle 109, the services 111, the at least one transactions database 113, the services platform 115, the services 117, the content providers 119, the at least one point of sale device 121, and the satellites 123. The communication module 203 may also be used to communicate commands, requests, data, etc. In one embodiment, the communication module 203 is used to determine one or more credentials associated with a user of the vehicle (e.g., the vehicle 109), the device (e.g., the UE 101), the one or more vehicle-based services (e.g., a parking service), the one or more other services (e.g., a service associated with an OEM), or a combination thereof. For example, a user can register one or more credentials (e.g., a username and password) in connection with a federal identity/account (e.g., a SSO identity or account). The user can also register their payment or account information (e.g., credit card numbers, bank account numbers, etc.) and the communication module 203 can access and then determine the one or more credentials via the communication network 105. The communication module 203 may also be used to cause, at least in part, at least one transmission of the location information, the contextual information, or a combination thereof to the one or more vehicle-based services (e.g., a parking service), the one or more other services (e.g., a service associated with an OEM), or a combination thereof.

The data collection module 205 in certain embodiments is used to determine payment information, billing information, or a combination thereof associated with one or more vehicle-related services. For example, the data collection module 205 can determine that the cost of parking on the street in an area or district of Berlin (e.g., Prenzlauer Berg) is 5 [symbol] /hour and that parking is free is from 18:00-06:00. Likewise, the data collection module 205 can determine that a payment was made to a service provider (e.g., 4.5 [symbol] for 43.21 minutes). The data collection module 205 may also be used to determine the payment information, the billing information, or a combination thereof from one or more POS devices associated with the one or more vehicle-related services (e.g. a parking service, a car wash, etc.). Further, the data collection module 205 also may be used to cause, at least in part, at least one aggregation of the payment information, the billing information, the one or more payments, or a combination thereof to enable at least one access of the one or more other services (e.g., an OEM service) via the navigation-based user interface.

In one embodiment, the rendering module 207 is used to cause, at least in part, a rendering of the payment information, the billing information, or a combination thereof on a navigation-based user interface associated with a vehicle (e.g., the vehicle 109), a device associated with the vehicle (e.g., the UE 101), or a combination thereof. For example, the rendering module 207 may render on the navigation-based user interface the cost of parking in an area, the status of payment, the total payment transferred when applicable, etc. The rendering module 207 may also be used to cause, at least in part, a rendering of a representation of a POI on the navigation-based user interface. Further, the rendering module 207 also may be used to cause, at least in part, a rendering of other payment information, other billing information, or a combination thereof associated with a POI on the navigation-based user interface based, at least in part, on at least one interaction with the interface. By way of example, when a user highlights or selects a POI (e.g., a parking garage), the rendering module 207 may cause the navigation-based user interface to display the relative POI information including payment and account related data in a new window, a side frame or menu, or as an enlarged icon over the map, for example.

In one or more embodiments, the analyzer module 209 is used to determine at least one POI associated with the location information, the contextual information, or a combination thereof determined by the context module 215. For example, the analyzer module 209 may determine that one or more parking garages, car washes, or fast food restaurants are in the vicinity of the vehicle 109 based, at least in part, on one or more services 117, one or more content providers 119, or a combination thereof, for example.

The UI module 211, in connection with the payment module 213, in certain embodiments is used to cause, at least in part, an initiation of one or more payments to the one or more vehicle-related services (e.g., a parking service) based, at least in part, on one or more interactions with the navigation-based user interface. By way of example, the UI module 211 may determine the one or more interactions with the navigation-based user interface based, at least in part, on a touch, a tapping, a long press, etc. In addition, the UI module 211 may determine the one or more interactions based, at least in part, on a voice command (e.g., “make payment”). Consequently, the payment module 213 can enable a payment to be made by a user from a federated identity/account, for example, to the POI (e.g., a parking garage). The UI module 211 may also be used to determine at least one interaction with the representation of the at least one POI. Again, a user may touch, tap, or long press the representation (e.g., a simplified glyph of a parking garage) or the user may say “parking garage.”

In one embodiment, the payment module 213 is used to process and/or facilitate a processing of the one or more payments to determine payment resolution information (e.g., payment deficiencies), payment history information (i.e., tracking), or a combination thereof. By way of example, a POS device (e.g., a MPPO for the use case of parking services) can record one or more user transactions (e.g., payments) initiated by the UI module 211. The data collection module 205 can then determine the payment information, the billing information, or a combination thereof, which the communication module 203 can then pass along to the payment module 213 for processing (e.g., tabulating the quantity of payments made to the one or more vehicle-related services).

In one or more embodiments, the update module 215 determines one or more transaction reports based, at least in part, on the one or more payments to cause, at least in part, at least one update of the payment information, the billing information, or a combination thereof to enable proper crediting to a user's account (e.g., a federated identity/account) and/or a monetization of the one or more user transactions (e.g., one or more payments).

The context module 217 in certain embodiment is used to determine location information, contextual information, or a combination thereof based, at least in part, on the vehicle, the device, or a combination thereof. For example, the context module 217 can determine the location of the device, for example, from the one or more location-based technologies associated with the device (e.g., GPS, cellular triangulation, A-GPS, etc.).

In one embodiment, the storage module 219 is used to manage the storage of one or more credentials (e.g., a username and password, federated identity/account information, credit card account numbers, bank account numbers, registration/subscription information, etc.), transactions records/reports, payment history information, POI information, one or more payment/billing restrictions (e.g., when the current information is within a threshold distance from the POI location), etc. in the at least one transactions database 113.

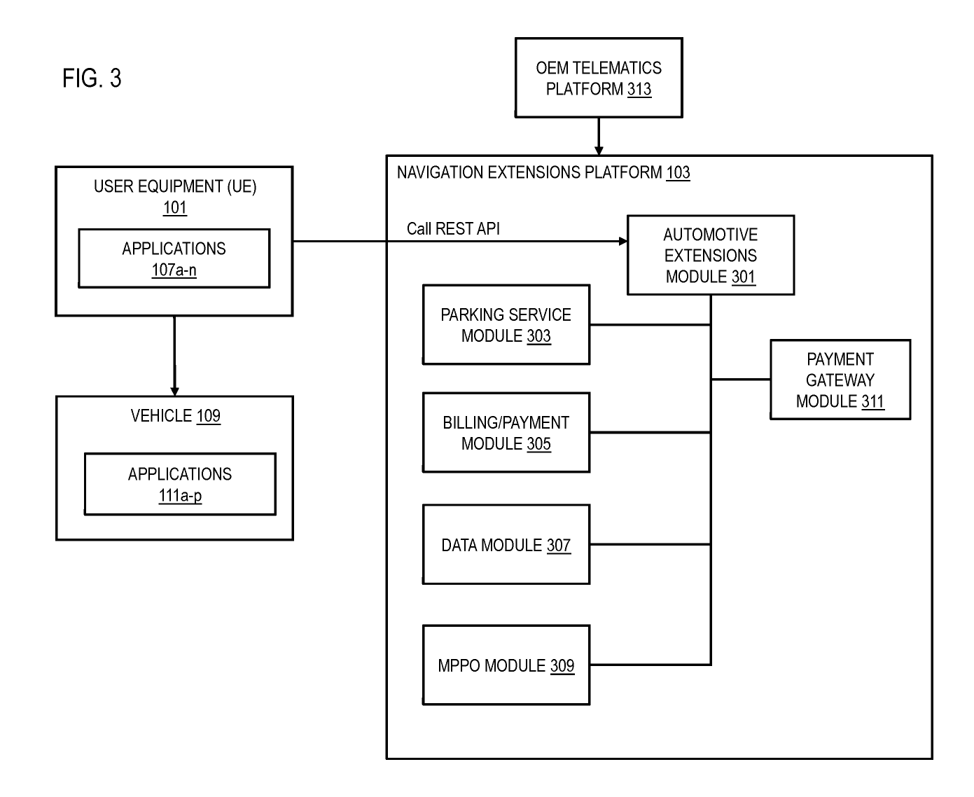

FIG. 3 is a diagram of the components of a navigation extensions platform 103 used in an automotive services context, according to one embodiment. More specifically, FIG. 3 is an example of accessing a parking service that is integrated with a navigation application executing on a head unit (e.g., an application 107 executing on the UE 101) installed by an OEM in a car (e.g., the vehicle 109). In particular, although FIG. 3 discusses an example parking service, it is contemplated that the various embodiments may apply to any service accessible via the navigation application or the head unit (e.g., toll payments, car washes, other driving services, etc.). In this embodiment, the navigation extensions platform 103 includes an automotive extensions module 301, a parking service module 303, a billing/payment module 305, a data module 307, a mobile parking payment operator (MPPO) module 309, and a payment gateway module 311.

In this example use case, a user can interact with the UE 101 (e.g., a head unit) to initiate a navigation application 107 to access a parking service. For example, the user can register with the parking service via the automotive extensions module 301 provided by the navigation extensions platform 103. In one embodiment, customer care agents, system administrators, and other personal associated with the parking service may manage the service via the administrative interface (not shown for illustrative convenience) also provided by the navigation extensions platform 103. For example, an OEM telematics platform 313 may access the automotive extensions module 301 via one or more APIs.

In one embodiment, the APIs can provide specific functionality related to payment and billing for the parking service, as well as APIs related to providing one or more functions of the parking service itself. These APIs, for instance, enable the navigation application 107 or the UE 101 to expose the parking service as well as payment and billing processes for the parking service to the user. As shown, the APIs enable the parking service module 303, in connection with the billing/payment module 305, to manage user subscriptions and entitlements as well as the billing and payments for the subscriptions. In addition, the APIs, in connection with the parking service module 303 and the data module 307, provide parking information logic as well as parking payment logic to one or more service providers. In one embodiment, the billing account and payment APIs, in connection with the billing/payment module 305, manage payment methods (e.g., credit cards payments).

In some embodiments, the parking service module 303 may operate with multiple parking service providers. Each of the parking service providers may be associated or include a payment operator to handle transactions (e.g., billing and payments) between the service and the users. In the context of a parking service, the payment operators may also be referred to as MPPOs. By way of example, the MPPOs and/or MPPO module 309 may operate via a payment gateway module 311 provided via the navigation extensions platform 103. In addition or alternatively, the parking service providers may each have their respective payment operator (PO) authorized payment gateway (not shown for illustrative convenience). The payment gateway module 311, in turn, provides payment data such as method of payment, account numbers (e.g., credit card account numbers, bank account numbers, etc.) for service payments.

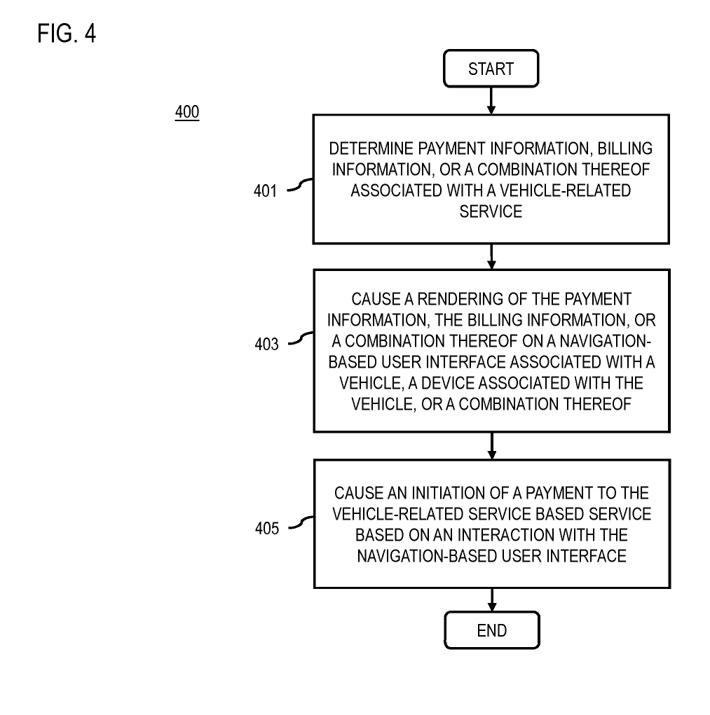

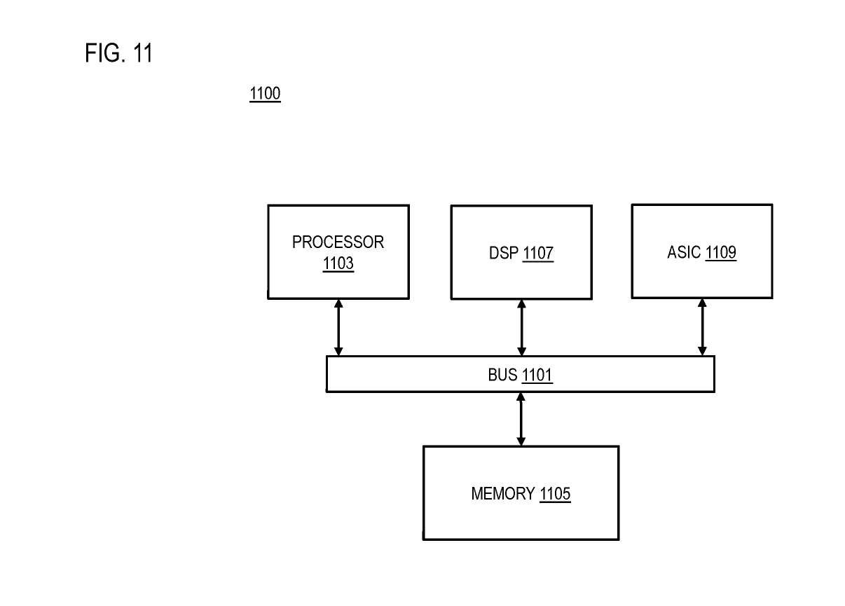

FIGS. 4-6 are flowcharts of processes for managing vehicle-related payment and/or billing transactions with a navigation-based user interface, according to one embodiment. In one embodiment, the navigation extensions platform 103 performs the process 400 and is implemented in, for instance, a chip set including a processor and a memory as shown in FIG. 11. In step 401, the navigation extensions platform 103 determines payment information, billing information, or a combination thereof associated with one or more vehicle-related services. By way of example, the one or more vehicle-related services include, at least in part, parking services, car washes, fuel services, tolls, fast food services, etc. By way of further example, the navigation extensions platform 103 can determine that parking on the street in Prenzlauer Berg, for example, costs 5 [symbol] /hour and is free from 18:00-6:00.

In step 403, the navigation extensions platform 103 causes, at least in part, a rendering of the payment information, the billing information, or a combination thereof on a navigation-based user interface associated with a vehicle, a device associated with the vehicle, or a combination thereof. For example, in a parking example use case, the navigation-based user interface of a mobile device (e.g., a mobile phone) may display the name of an area or district of a city (e.g., Prenzlauer Berg of Berlin, Germany), the cost of parking in that area (e.g., on the street parking—5 [symbol] /hour and free 18:00-06:00), the status of payment (e.g., payment started, payment stopped, etc.), the total payment transferred where applicable (e.g., 4.5 [symbol] for 43:21 minutes), etc.

In step 405, the navigation extensions platform 103 causes, at least in part, an initiation of one or more payments to the one or more vehicle-related services based, at least in part, on one or more interactions with the navigation-based user interface. In one example use case, the one or more interactions may include, at least in part, a touch, a tapping, a long press, a voice command, etc. By way of example, the navigation-based user interface may include, at least in part, a “start payment”/“stop payment” interactive interface element and once a user interacts with this element, the navigation extensions platform 103 can initiate the one or more payments to the one or more vehicle-related services (e.g., a parking garage). By way of further example, the navigation extensions platform 103 may display a map on the navigation-based user interface depicting one or more POIs. In one embodiment, if the POI has a visual indication that it is one-click payment ready, then the navigation extensions platform 103 can enable a user to initiate the payment (e.g., from a federated identity/account) by simply selecting the POI (e.g., tapping).

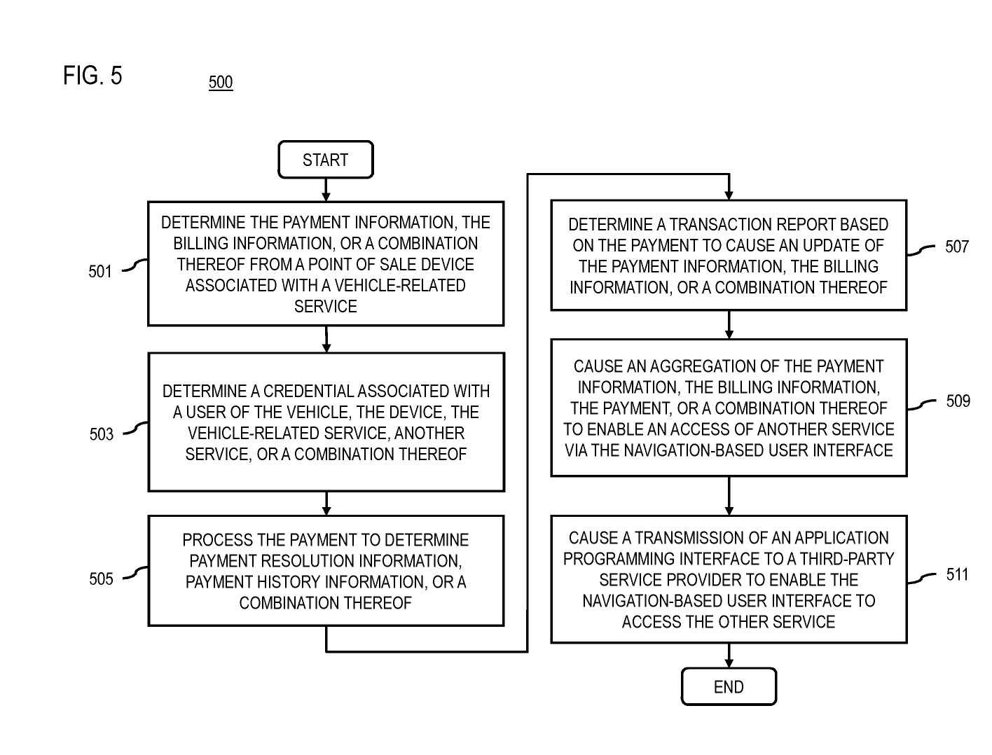

FIG. 5 depicts a process 500 of processing and/or facilitating a processing of payment information, billing information, or a combination thereof in connection with one or more vehicle-related services, one or more other services, or a combination thereof. In one embodiment, the navigation extensions platform 103 performs the process 500 and is implemented in, for instance, a chip set including a processor and a memory as shown in FIG. 11. In step 501, the navigation extensions platform 103 determines the payment information, the billing information, or a combination thereof from one or more point of sale devices associated with the one or more vehicle-related services. In one example use case, the POS devices include, at least in part, MPPOs for the use case of parking services. Moreover, in one embodiment, the POS devices and/or MPPOs record user transactions conducted via the navigation extensions platform 103.

In step 503, the navigation extensions platform 103 determines one or more credentials associated with a user of the vehicles, the devices, the one or more vehicle-based services, the one or more other services, or a combination thereof, wherein the one or more payments are based, at least in part, on the one or more credentials. By way of example, a user can register with the navigations extensions platform 103 to create a user account including, at least in part, a username and password. Moreover, the user may register for an account as part of a federated identity/account (e.g., a SSO identity or account). In addition, the user can also register his or her payment or account information as one or more credentials (e.g., credit card numbers, bank account numbers, etc.) and can link their parking service billing account with their federated identity/account.

In step 505, the navigation extensions platform 103 processes and/or facilitates a processing of the one or more payments to determine payment resolution information, payment history information, or a combination thereof. In particular, in one embodiment, the navigation extensions platform 103, the services platform 115, the services 117, and/or the content providers 119 are associated with at least one point of sale device 121 (e.g., a MPPO for the use case of parking services). In one embodiment, the at least one POS device 121 and/or a MPPO records transactions (e.g. payments) conducted via the navigation extensions platform 103. The user transactions records then, for example, can be reported back to the navigation extensions platform 103 by the at least one POS device 121, for example, to compile payment resolution information (e.g., payment discrepancies), payment history information (i.e., tracking), or a combination thereof.

In step 507, the navigation extensions platform 103 determines one or more transaction reports based, at least in part, on the one or more payments to cause, at least in part, at least one update of the payment information, the billing information, or a combination thereof. By way of example, the at least one update of the payment information may include, at least in part, a proper crediting to a user's account (e.g., a federated identity/account) by the navigation extensions platform 103. In addition, in some embodiments, the one or more transactions reports may be used for monetizing the one or more user transactions. Moreover, in one embodiment, the navigation extensions platform 103 may include or be referred to as a monetization platform 103 or service. The monetization platform 103, for example, can enable the interaction of subscription and/or payment enablers (e.g., payment methods such as credit cards, operator billing, third-party money accounts, etc.) with the navigation extensions platform 103.

In step 509, the navigation extensions platform 103 causes, at least in part, at least one aggregation of the payment information, the billing information, the one or more payments, or a combination thereof to enable at least one access of one or more other services via the navigation-based user interface. By way of example, the one or more other services include, at least in part, additional services or functionalities provided by the services platform 115, the services 117, and/or the content providers 119 (e.g., one or more OEM services). In particular, in one embodiment, the navigation extensions platform 103 and/or the monetization platform 103 can cause, at least in part, an aggregation of one or more user transactions and related billing/payments across multiple services, multiple instances of the services, a POS device or MPPO (e.g., parking services), one type of service from multiple POSs or MPPOs, and/or multiple types of services from multiple POSs or MPPOs. In addition, in one embodiment, the navigation extensions platform 103 supports aggregation of one or more transactions for more efficient processing. For example, one or more transactions can be aggregated by the navigation extensions platform 103 based on time, wherein the one or more transactions are collected for a period of time (e.g., a week, a month, etc.) and then processed by the navigation extensions platform 103 collectively at the end of the period.

In step 511, the navigation extensions platform 103 causes, at least in part, at least one transmission of one or more application programming interfaces to one or more third-party service providers to enable the navigation-based user interface to access the one or more other services. By way of example, an OEM/third-party responsible for manufacturing the UE 101 and/or one or more mapping and/or navigation applications 107 may access the APIs of the navigation extension platform 103 to enable billing and payment functions. In addition, in one embodiment, the navigation extensions platform 103 may expose one or more APIs to support subscriptions and entitlements for one or more services (e.g., parking services) as well as for payments for the subscriptions and entitlements. For example, a user can interact with a subscription API through a navigation application 107, the UE 101 (e.g., a head unit, a mobile phone, a tablet, etc.). In particular, the subscription API enables signaling of the user's intent to initiate a subscription with a navigation-related service. Once the subscription is initiated, the internal entitlement API manages the specific service, functions, data (e.g., mapping data), etc. to which the user is entitled based on his or her subscription.

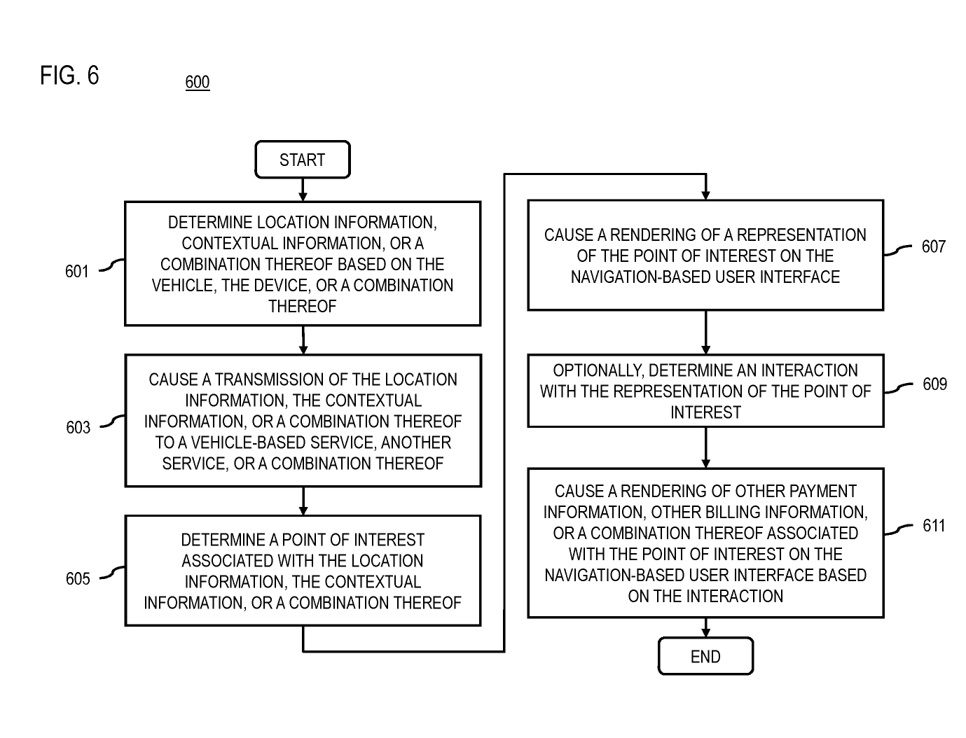

FIG. 6 depicts a process 600 of processing and/or facilitating a processing of location information, contextual information, point of interest information, or a combination thereof. In one embodiment, the navigation extensions platform 103 performs the process 600 and is implemented in, for instance, a chip set including a processor and a memory as shown in FIG. 11. In step 601, the navigation extensions platform 103 determines location information, contextual information, or a combination thereof based, at least in part, on the vehicle, the device, or a combination thereof. By way of example, the UE 101 (e.g., a mobile phone, a tablet, a personal navigation device, and/or an infotainment system) may be configured with one or more location-based technologies (e.g., GPS, cellular triangulation, A-GPS, etc.) to facilitate navigation and other location-based applications and/or services and in some cases, the UE 101 is associated with or otherwise installed in the vehicle 109. As a result, the navigation extensions platform 103 can determine the location and/or context of the vehicle, the device, or a combination thereof. For example, in one example use case, the navigation extensions platform 103 can determine that the vehicle 109, for example, is in the Prenzlauer Berg district or region of Berlin, for example, where on the street parking is 5 [symbol] /hour and parking is free from 18:00-06:00.

In step 603, the navigation extensions platform 103 causes, at least in part, at least one transmission of the location information, the contextual information, or a combination thereof to the one or more vehicle-based services, the one or more other services, or a combination thereof. By way of example, payment/billing may be restricted to certain locations (e.g., on a specified route, when the current location and a POI location are substantially the same, when the current location is within a threshold distance from the POI location, etc.) or the amount of payment may depend on a specific location (e.g., parking is free on the home street of a user, an employer has paid parking fees close to the office, etc.).

In step 605, the navigation extensions platform 103 determines at least one point of interest associated with the location information, the contextual information, or a combination thereof. For example, the navigation extensions platform 103 may determine that a parking lot or garage, a car wash, etc. is in the vicinity of the vehicle, the device, or a combination thereof based, at least in part, on one or more services, one or more content providers, or a combination thereof, for example. Then, in step 607, the navigation extensions platform 103 causes, at least in part, a rendering of a representation of the at least one point of interest on the navigation-based user interface. For example, the navigation extensions platform 103 may render a POI (e.g., a parking garage, a car wash, a gas station, etc.) as a simplified glyph. In addition, the representation may include information such as an indication of a user's account status relative to the service provider of the POI (e.g., “existing valid contract,” “no contract,” “no access,” “payment due,” “ready for one-click payment,” etc.).

In step 609, the navigation extensions platform 103 optionally determines at least one interaction with the representation of the at least one point of interest. By way of example, the at least one interaction may include, at least in part, a touch, a tapping, a long press, a voice command, or a combination thereof. For example, the navigation extensions platform 103 can determine that a user has tapped a parking lot icon or glyph, has said a voice command such as “parking lot,” etc. Then, in step 611, the navigation extensions platform 103 causes, at least in part, a rendering of other payment information, other billing information, or a combination thereof associated with the at least one point of interest on the navigation-based user interface based, at least in part, on the at least one interaction. For example, in one embodiment, when a user highlights or selects a POI, POI information including payment and account related data can be presented by the navigation extensions platform 103 on the navigation-based user interface (e.g., on a new window, a side frame or menu, an enlarged icon over a map, etc.). More specifically, the display payment and account data may show information such as service descriptions and pricing details that are need for a user to decide to make a one-click payment. In one example use case, the other payment information, the other billing information, or a combination thereof relates to the one or more POIs as opposed to the one or more vehicle-related services. However, in one embodiment, it is also contemplated that the one or more POIs also offer one or more vehicle-related services.

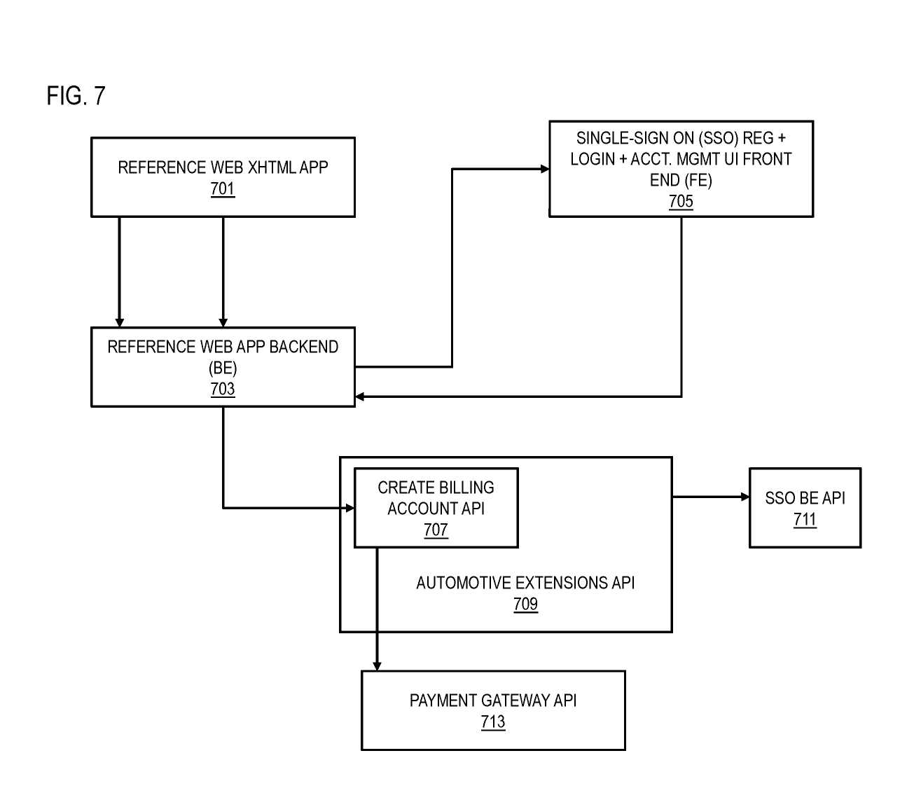

FIG. 7 is a diagram depicting a process flow for a navigation application (e.g., an application 107) operating in association with the navigation extensions platform 103, according to one embodiment. In step 1, the reference web extensible hypertext markup language (XHTML) application 701 sends a request to register a new account or to sign on an existing account to a reference web application backend (BE) platform 703. In step 2, the reference web application BE 703 forwards the request to the SSO registration/login/account management user interface front end (FE) platform 705. The FE platform 705 then returns an SSO token to the reference web application BE 703 to indicate proper sign-on and authentication.

Once the SSO account is created, in step 3, the reference web application XHTML 701 sends another request to the reference web application BE 703 to create a specific service account (e.g., a parking service account). In step 4, the reference web application BE forwards the request along with the SSO token to the create billing account API 707 of the automotive extensions API 709 to create the billing account. On receipt of the request, the automotive extensions API 709 authenticates the SSO token via the SSO BE API 711 in step 5. After authentication of the SSO token, the encrypted billing account data (e.g., credit card data) is forwarded in step 6 to the payment gateway API 713 to support one or more service payments.

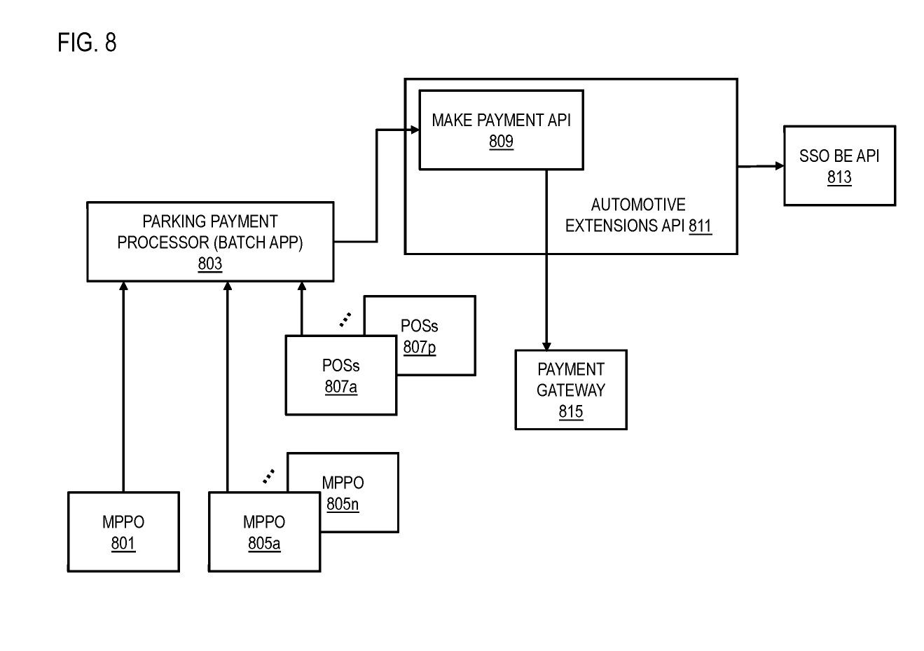

FIG. 8 is a diagram depicting a payment flow for a parking service operating in association with the navigation extension platform 103, according to one embodiment. In step 1, a parking service provider 801 (e.g., an MPPO) logs and reports all usage records (e.g., both paid and unpaid transactions) to the parking payment processor 803. Alternatively, in an aggregation use case, multiple parking service providers 805a-805n (e.g., from different regions such as Denmark, Sweden, and the United Kingdom) may log and report usage records to the parking payment processor 803. In yet another aggregation use case, different service providers (not shown for illustrative convenience) may log and send usage records to the parking payment processor 803 via respective POSs 807a-807p. In particular, the second aggregation use case provides for generalization of the process to multiple services providers that provide other types of services than parking services. In this way, the parking payment processor 803 becomes a general payment processor that handles one or more transactions from a variety of service types.

In step 2, the parking payment processor 803 stores and batches the records for subsequent processing. Once a batch of the usage records are created, the parking payment processor 803 in step 3 sends a payment request to the make payment API 809 of the automotive extensions API 811 based on the usage.

In step 4, the user account associated with the usage records is validated with the SSO BE API 813. For example, the usage records may be accompanied with an SSO taken for validation. Once validated, a parking transaction record is created in step 5.1 with a pending status. Then in step 5, the make payment API 809 forwards billing account or other payment information to the payment gateway API 815 for payment processing. Once a successful payment is made, the parking transaction record is updated in step 6 to show an active status.

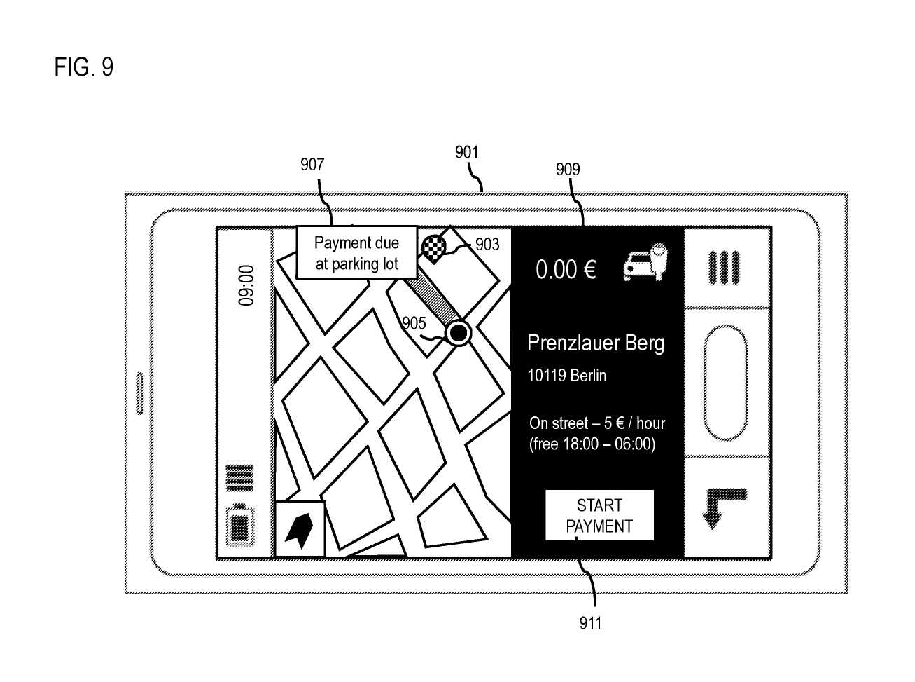

FIG. 9 is a diagram of a user interface utilized in the processes of FIGS. 4-6, according to various embodiments. As shown, the example use interface of FIG. 9 includes one or more user interface elements and/or functionalities created and/or modified based, at least in part, on information, data, and/or signals resulting from the processes (e.g., 400, 500, and 600) described with respect to FIGS. 4-6. More specifically, FIG. 9 illustrates an interface 901 (e.g., a mobile phone depicting a mapping and/or navigation application), depicting one or more POIs (e.g., a parking lot 903) and a representation of a vehicle 905 (e.g., the vehicle 109).

In one embodiment, once the system 100 determines location information, contextual information, or a combination thereof based, at least in part, on the vehicle 905, the interface 901, or a combination thereof (e.g., a GPS receiver associated with the interface 901), the system 100 can determine at least one POI (e.g., the parking lot 903) associated with the location information, the contextual information, or a combination thereof. In this example use case, the vehicle 905 and the interface 901 are located in the Prenzlauer Berg area or district of Berlin, Germany and are in close proximity to the parking lot 903. In one embodiment, the system 100 then causes, at least in part, a rendering of a representation of the at least one POI (e.g., a checkered POI symbol 903) within the navigation-based user interface of interface 901. As previously discussed, the at least one POI may include some visual indication 907 of a user's account status relating to the service provider of the parking lot 903 based, at least in part, on the user's one or more credentials (e.g., a federated identity/account) previously determined by the system 100. By way of example, the visual indication 907 may include, at least in part, information such as “existing valid contract,” “no contract,” “no access,” “payment due,” “ready for one-click payment,” etc. In this example use case, the visual indication 907 states “payment due at parking lot.”

In one or more embodiments, the system 100 can determine at least one interaction with the representation of the at least one POI (e.g., the parking lot 903). By way of example, the system 100 can determine that a user has tapped the parking lot icon 903 or has stated a voice command (e.g., “parking lot”). In one or more embodiments, the system 100 causes, at least in part, a rendering of other payment information, other billing information, or a combination thereof associated with the parking lot 903 on the navigation-based user interface of interface 901 based, at least in part, on the least one interaction (e.g., a tapping in this case). In this example use case, the system 100 renders the other payment information as a side frame or menu 909. However, it is contemplated that the system 100 can also present the information as a new window, an enlarged icon over a map, or a combination thereof. In this example use case, the side frame 909 indicates that the cost of parking on the street is 5 [symbol] /hour and parking is free 18:00-06:00. In this example use case, the time depicted is 09:00. Therefore, the parking on the street is 5 [symbol] /hour and not free. Moreover, in this example use case, once the user arrives at the parking lot 903, he or she can select the interface element 911 (e.g., “start payment”) to cause, at least in part, an initiation of one or more payments by the system 100 to the one or more vehicle-related services (e.g., the parking lot 903). Likewise, once the user is ready to leave the parking lot 903, he or she can select the interface element 911 (e.g., “stop payment”) to cause, at least in part, the termination of the one or more payments.

The processes described herein for managing vehicle-related payment and/or billing transactions with a navigation-based user interface may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

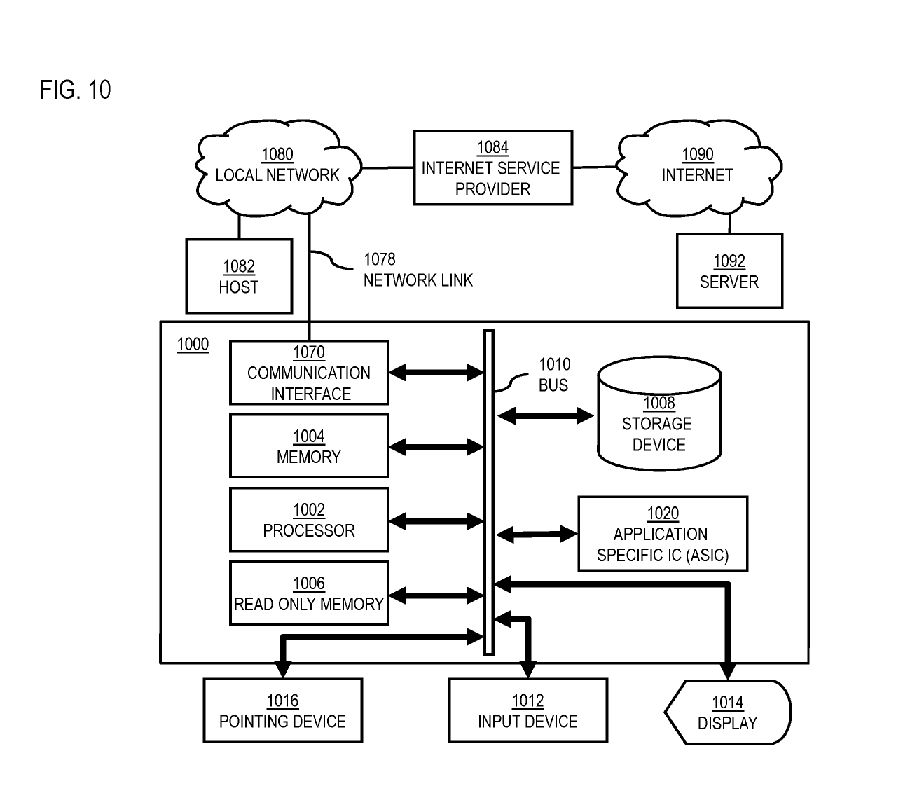

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 10 can deploy the illustrated hardware and components of system 1000. Computer system 1000 is programmed (e.g., via computer program code or instructions) to manage vehicle-related payment and/or billing transactions with a navigation-based user interface as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of managing vehicle-related payment and/or billing transactions with a navigation-based user interface.

A bus 1010 includes one or more parallel conductors of information so that information is transferred quickly among devices coupled to the bus 1010. One or more processors 1002 for processing information are coupled with the bus 1010.

A processor (or multiple processors) 1002 performs a set of operations on information as specified by computer program code related to manage vehicle-related payment and/or billing transactions with a navigation-based user interface. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1000 also includes a memory 1004 coupled to bus 1010. The memory 1004, such as a random access memory (RAM) or any other dynamic storage device, stores information including processor instructions for managing vehicle-related payment and/or billing transactions with a navigation-based user interface. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or any other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for managing vehicle-related payment and/or billing transactions with a navigation-based user interface, is provided to the bus 1010 for use by the processor from an external input device 1012, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT), a liquid crystal display (LCD), a light emitting diode (LED) display, an organic LED (OLED) display, a plasma screen, or a printer for presenting text or images, and a pointing device 1016, such as a mouse, a trackball, cursor direction keys, or a motion sensor, for controlling a position of a small cursor image presented on the display 1014 and issuing commands associated with graphical elements presented on the display 1014. In some embodiments, for example, in embodiments in which the computer system 1000 performs all functions automatically without human input, one or more of external input device 1012, display device 1014 and pointing device 1016 is omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of ASICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 105 for managing vehicle-related payment and/or billing transactions with a navigation-based user interface to the UE 101.

The term “computer-readable medium” as used herein refers to any medium that participates in providing information to processor 1002, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1008. Volatile media include, for example, dynamic memory 1004. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 1000 in response to processor 1002 executing one or more sequences of one or more processor instructions contained in memory 1004. Such instructions, also called computer instructions, software and program code, may be read into memory 1004 from another computer-readable medium such as storage device 1008 or network link 1078. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server host 1092 transmits program code for a particular application, requested by a message sent from computer 1000, through Internet 1090, ISP equipment 1084, local network 1080 and communications interface 1070. The received code may be executed by processor 1002 as it is received, or may be stored in memory 1004 or in storage device 1008 or any other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

FIG. 11 illustrates a chip set or chip 1100 upon which an embodiment of the invention may be implemented. Chip set 1100 is programmed to manage vehicle-related payment and/or billing transactions with a navigation-based user interface as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of providing user interface navigation information associated with the availability of functions. Chip set or chip 1100, or a portion thereof, constitutes a means for performing one or more steps of managing vehicle-related payment and/or billing transactions with a navigation-based user interface.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1100 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to manage vehicle-related payment and/or billing transactions with a navigation-based user interface. The memory 1105 also stores the data associated with or generated by the execution of the inventive steps.

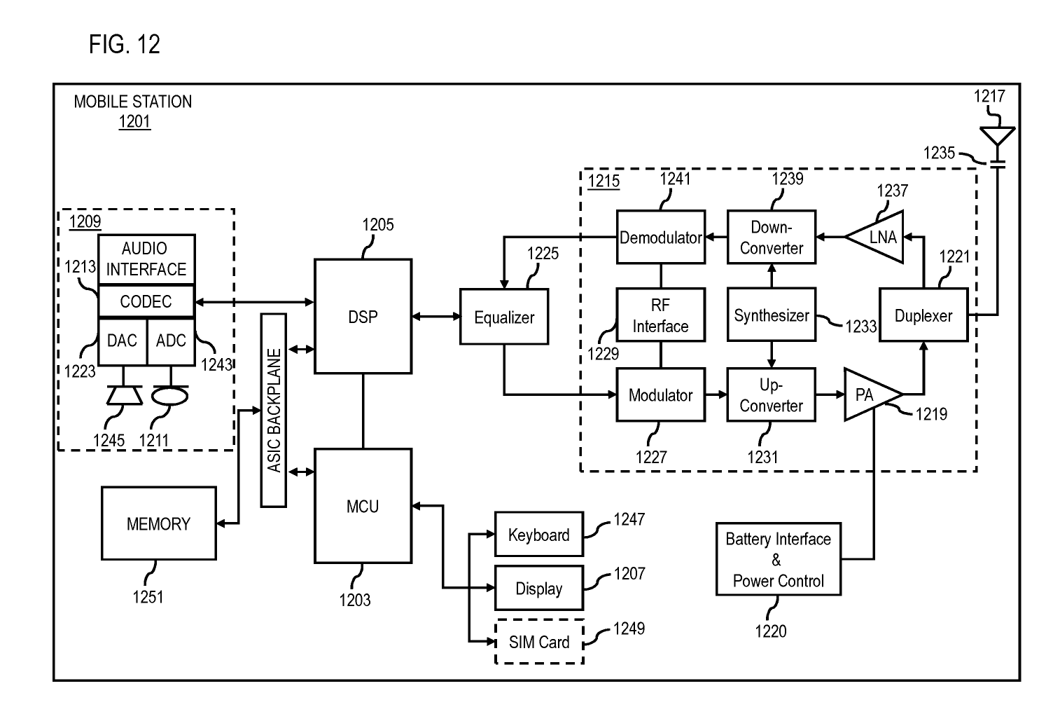

FIG. 12 is a diagram of exemplary components of a mobile terminal (e.g., handset) for communications, which is capable of operating in the system of FIG. 1, according to one embodiment. In some embodiments, mobile terminal 1201, or a portion thereof, constitutes a means for performing one or more steps of managing vehicle-related payment and/or billing transactions with a navigation-based user interface. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of managing vehicle-related payment and/or billing transactions with a navigation-based user interface. The display 1207 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203 which can be implemented as a Central Processing Unit (CPU).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 to manage vehicle-related payment and/or billing transactions with a navigation-based user interface. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-38. (canceled)

39. A method comprising:
determining payment information, billing information, or a combination thereof associated with one or more vehicle-related services registered by a user of a vehicle, a device associated with the vehicle, or a combination thereof;
causing, at least in part, a rendering of the payment information, the billing information, or a combination thereof relating to the one or more vehicle-based services on a navigation-based user interface associated with the vehicle, the device associated with the vehicle, or the combination thereof; and
causing, at least in part, an initiation of one or more payments to the one or more vehicle-related services based, at least in part, on one or more user interactions with the navigation-based user interface according to the determined payment information, billing information, or the combination thereof.

40. A method of claim 39, further comprising:
determining the payment information, the billing information, or a combination thereof from one or more point of sale devices associated with the one or more vehicle-related services.

41. A method of claim 39, further comprising:
processing and/or facilitating a processing of the one or more payments to determine payment resolution information, payment history information, or a combination thereof.

42. A method of claim 39, further comprising:
determining one or more transaction reports based, at least in part, on the one or more payments to cause, at least in part, at least one update of the payment information, the billing information, or a combination thereof.

43. A method of claim 39, further comprising:
causing, at least in part, at least one aggregation of the payment information, the billing information, the one or more payments, or a combination thereof to enable at least one access of one or more other services via the navigation-based user interface.

44. A method of claim 39, further comprising:
causing, at least in part, at least one transmission of one or more application programming interfaces to one or more third-party service providers to enable the navigation-based user interface to access the one or more vehicle-based services, one or more other services, or a combination thereof.

45. A method of claim 39, further comprising:
determining location information, contextual information, or a combination thereof based, at least in part, on the vehicle, the device, or a combination thereof; and
causing, at least in part, at least one transmission of the location information, the contextual information, or a combination thereof to the one or more vehicle-based services, one or more other services, or a combination thereof.

46. A method of claim 45, further comprising:
determining at least one point of interest associated with the location information, the contextual information, or a combination thereof; and
causing, at least in part, a rendering of a representation of the at least one point of interest on the navigation-based user interface.

47. A method of claim 46, further comprising:
determining at least one interaction with the representation of the at least one point of interest; and
causing, at least in part, a rendering of other payment information, other billing information, or a combination thereof associated with the at least one point of interest on the navigation-based user interface based, at least in part, on the at least one interaction.

48. A method of claim 39, further comprising:
determining one or more credentials associated with the user of the vehicle, the device, the one or more vehicle-based services, one or more other services, or a combination thereof,
wherein the one or more payments are based, at least in part, on the one or more credentials.

49. An apparatus comprising:
at least one processor; and
at least one memory including computer program code for one or more programs,
the at least one memory and the computer program code configured to, with the at least one processor, cause the apparatus to perform at least the following,
determine payment information, billing information, or a combination thereof associated with one or more vehicle-related services registered by a user of a vehicle, a device associated with the vehicle, or a combination thereof;
cause, at least in part, a rendering of the payment information, the billing information, or a combination thereof relating to the one or more vehicle-based services on a navigation-based user interface associated with the vehicle, the device associated with the vehicle, or the combination thereof; and
cause, at least in part, an initiation of one or more payments to the one or more vehicle-related services based, at least in part, on one or more user interactions with the navigation-based user interface according to the determined payment information, billing information, or the combination thereof.

50. An apparatus of claim 49, wherein the apparatus is further caused to:
determine the payment information, the billing information, or a combination thereof from one or more point of sale devices associated with the one or more vehicle-related services.

51. An apparatus of claim 49, wherein the apparatus is further caused to:
process and/or facilitate a processing of the one or more payments to determine payment resolution information, payment history information, or a combination thereof.

52. An apparatus of claim 49, wherein the apparatus is further caused to:
cause, at least in part, at least one aggregation of the payment information, the billing information, the one or more payments, or a combination thereof to enable at least one access of one or more other services via the navigation-based user interface.

53. An apparatus of claim 49, wherein the apparatus is further caused to:
cause, at least in part, at least one transmission of one or more application programming interfaces to one or more third-party service providers to enable the navigation-based user interface to access the one or more vehicle-based services, one or more other services, or a combination thereof.

54. An apparatus of claim 49, wherein the apparatus is further caused to:
determine location information, contextual information, or a combination thereof based, at least in part, on the vehicle, the device, or a combination thereof; and
cause, at least in part, at least one transmission of the location information, the contextual information, or a combination thereof to the one or more vehicle-based services, one or more other services, or a combination thereof.

55. An apparatus of claim 54, wherein the apparatus is further caused to:
determine at least one point of interest associated with the location information, the contextual information, or a combination thereof; and
cause, at least in part, a rendering of a representation of the at least one point of interest on the navigation-based user interface.

56. An apparatus of claim 55, wherein the apparatus is further caused to:
determine at least one interaction with the representation of the at least one point of interest; and
cause, at least in part, a rendering of other payment information, other billing information, or a combination thereof associated with the at least one point of interest on the navigation-based user interface based, at least in part, on the at least one interaction.

57. An apparatus of claim 49, wherein the apparatus is further caused to:
determine one or more credentials associated with the user of the vehicle, the device, the one or more vehicle-based services, one or more other services, or a combination thereof,
wherein the one or more payments are based, at least in part, on the one or more credentials.

58. A non-transitory computer-readable storage medium carrying one or more sequences of one or more instructions which, when executed by one or more processors, cause an apparatus to perform at least;
determining payment information, billing information, or a combination thereof associated with one or more vehicle-related services registered by a user of a vehicle, a device associated with the vehicle, or a combination thereof;
causing, at least in part, a rendering of the payment information, the billing information, or a combination thereof relating to the one or more vehicle-based services on a navigation-based user interface associated with the vehicle, the device associated with the vehicle, or the combination thereof; and
causing, at least in part, an initiation of one or more payments to the one or more vehicle-related services based, at least in part, on one or more user interactions with the navigation-based user interface according to the determined payment information, billing information, or the combination thereof.
